(19) United States
(12) Patent Application Publication
(10) Pub. No.: US 2007/0022850 A1
(43) Pub. Date: Feb. 1, 2007

(54) Cutting and transport cylinder in a winding device for winding material webs

(76) Inventors: Thomas Altesellmeier, Lienen (DE); Oliver Koser, Lengerich (DE); Rolf Kammann, Westerkappein (DE); Werner Decker, Ladbergen (DE)

Correspondence Address: JACOBSON HOLMAN PLLC, 400 SEVENTH STREET N.W., SUITE 600, WASHINGTON, DC, 20004, US

(21) Appl. No.: 10/556,423

(22) PCT Filed: May 6, 2004
(86) PCT No.: PCT/EP04/04892

§ 371 Date: Nov. 9, 2005

(30) Foreign Application Priority Data
May 14, 2003 (DE) 103 21 778.9

(51) Int. Cl. B26D 1/00; B26D 7/06

(52) U.S. Cl. 83/13; 83/304; 83/98; 83/402

(57) ABSTRACT

Cutting and transport roller (1) for material webs,
that comprises of media outlet openings (14) in its peripheral surface (7) to which varying pressure can be applied to control the seating pattern of the material web on the peripheral surface (7) of the roller (1) and
that comprises of a system of pressure feed lines (3, 4, 5, 11, 12, 13) by means of which the media outlet openings (14) are connected to means for supplying the media. The present invention differs from the prior art by
at least one pressure reservoir (3, 4)
   that (3, 4) is a part of the pressure feed line system (3, 4, 5, 11, 12, 13) and that can be connected by a valve to at least one part of the media outlet openings.

In the present invention, a process is introduced and claimed for controlling the seating pattern of a material web on the peripheral surface of a cutting- and transport roller (1). Said process can be implemented using the roller (1) in accordance with the invention.

This is a nationalization of PCT/EP2004/004892 filed 6 May 2004 and published in German.

The present invention relates to a cutting and transport roller in accordance with the preamble of the main claim 1 as well as a process for controlling the seating pattern of a material web on the peripheral surface of the roller according to the preamble of the claim 6.

A cutting and transport roller of this type is known from the patent application EP 0 698 671 A1. The roller described there comprises of an inner hollow space into which a separating body is inserted. This separating body and the outer shell of the roller delimit pressure rooms. The pressure rooms are in contact with the ambient by means of a penetrating borehole in the peripheral surface of the roller. The pressure rooms can be connected to the sources of high pressure and low pressure arranged outside the roller by means of pressure media lines so that, if necessary, a state of high pressure or low pressure is created in the pressure rooms that acts on the material web running on the peripheral surface of the roller. Thus the material web is either laid down (low pressure) to the roller or pushed away (high pressure) from it.

The roller described is generally used in winding devices for winding up material webs. In such a device the material web has to be severed after a complete roll is formed and the start of the new web is placed on a new winding core. Cutters are used for the purpose of cutting the web. These cutters are even integrated into the roller in newer winding devices. One such cutter is described, for instance, in the patent application DE 100 47 545 A1. The cutting elements of these cutters briefly pass through the peripheral surface of the roller and thus cut through the material web. At the same moment low pressure is applied to the pressure rooms so that the material web is held on to the roller. If the start of the web now reaches the new winding core, then high pressure is applied to the pressure rooms. Consequently, the material web is pushed away from the roller and onto the winding core. This process is referred to as the initial winding process.

The cutting and transport roller described in the patent application EP 0698 671 A1 comprises of voluminous hollow spaces in its interior through which the media conveying the pressure—usually air, of course—are supplied to the media outlet openings. Here these media are supplied to the roller by the so-called ‘pressure sources,’ which can be pumps, for instance.

In practice, it has been seen that the processes of laying down the material web on the roller and/or pushing it away from the roller do not take place reliably at high peripheral speed using the device described.

Therefore the objective of the present invention is to suggest a cutting and transport roller, with which it is possible to execute the processes of laying down the material web on the roller and/or pushing it away from the roller more reliably even at high peripheral speeds.

This objective is achieved by the characteristics specified in claim 1.

By means of the pressure reservoir, the desired amount of pressure can be applied to the media outlet openings almost instantaneously. In this case, pumps require a lead time for this purpose.

In this connection, it is advantageous if the valve delimiting the pressure reservoir is attached as close as possible to the media outlet openings. This is especially the case if voluminous chambers are provided as pressure lines as in case of the patent application EP 0698 671 A1.

A valve of such type can be designed as a toggle switch, with which it is possible to switch back and forth between the different pressure levels. However, it is also possible to provide several valves that can be operated as single throw-switches. In case of both the embodiments, it is advantageous if high pressure or low pressure is already applied to the valves on one side and if a pressure change occurs at the media outlet openings during operation of the valves in the shortest period of time. In this manner it is possible to control the seating pattern of the material web on the peripheral surface of the roller in terms of time with substantially more precision as compared to the described process known to prior art. It is preferred to use air as the medium for this purpose.

In a third embodiment of the present invention, the cutting and transport roller comprises of a pressure reservoir arranged in the roller and whose connection to the media outlet openings can be interrupted by at least one valve. The use of two pressure reservoirs, one each for high pressure and low pressure is preferred. This ensures the immediate availability of high or low pressure, whenever required. Furthermore, the advantage of arranging the pressure reservoir inside the roller is that the media supply system does not comprises of any rotary feedthroughs that can result in the loss of media. Thus the present invention makes it possible to also provide higher pressures.

In a preferred fourth embodiment of the present, invention, the pressure reservoir is designed as a media tank inserted into the roller as a separate component. Designing the roller in this manner reduces the manufacturing costs considerably.

It is advantageous if the walls of the roller and those of the media tank form a line of contact to the maximum extent possible. Here, the media tanks can be designed, for instance, as cylinders.

In a particularly preferred fifth embodiment of the present invention, the roller and the pressure reservoir have independent walls. Thus the media tanks can be arranged in such a manner that their principal inertial axes coincide with the axis of rotation of the roller. Pressure media of varying pressures can then be applied to the pressure media tanks from outside by means of pipelines. This process can also take place at a point of time at which the media are not released from the media reservoir. Here, it does not matter if the media are lost due to the required rotary feedthroughs.

In addition, the present invention includes a process for controlling the seating pattern of a material web on the peripheral surface of a cutting and transport roller. Generally this process is used for the execution of the afore-mentioned initial winding process in a more precise manner in terms of time and thus more reliably particularly at high peripheral speeds as compared to the process that is discussed above and is known from the patent application EP 0698 571 A1. While executing the process according to the present invention, first a static pressure is built up in the components of the pressure supply system by the means for providing media of varying pressure. This pressure is applied to the media outlet openings when the valves are opened.

Thus a pressure is first built up, which is then available directly at the media outlet openings when the valves are opened. In the process according to the present invention, the supply times of the pressure difference are very small and can be ignored by possibly using a control unit.

Here, it is advantageous if the means for providing the media of varying pressure continue to operate even when the valves are opened. Thus the pressure at the media outlet openings can be kept constant even over a longer timeframe.

Moreover, it is particularly advantageous if the means for providing the media of varying pressure continue to operate when the valves are closed till a predetermined amount of pressure is built up.

A sixth preferred embodiment of this invention is based on the present description and the accompanying drawing of which the single FIGURE illustrates a perspective view of a cutting and transport roller according to the present invention.

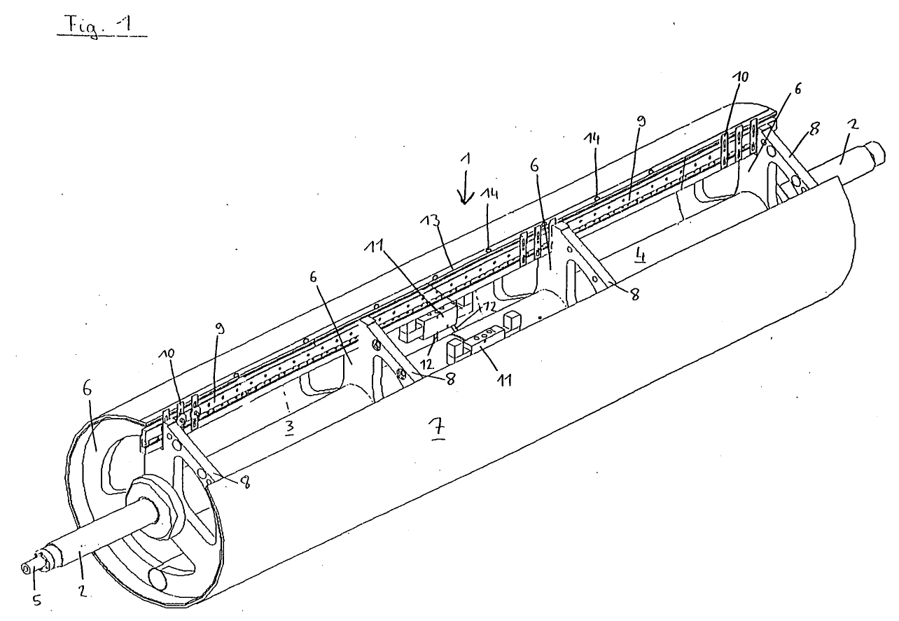

FIG. 1 illustrates a cutting- and transport roller 1, whose ends comprise of bearing pins 2. Located between the two bearing pins 2 are two media tanks 3, 4 that together with the bearing pin 2 form the components of the axis of the cutting- and transport roller 1. The bearing pins 2 are penetrated in the axial direction by pipe penetrations 5 by means of which media can be applied to the media tanks 3, 4. On the media tanks 3, 4, circular disk-shaped web plates 6 are fitted that support the outer shell 7 of the roller. The web plates 6 comprise of flat portions 8 on which it is possible to attach a flap opening (not illustrated) for the purpose of maintenance. The web plates 6 support additionally the cutter 9, of which a few cutting knives 10 have been illustrated as examples. The patent application DE 100 47 545 A1 can be referred to for a more detailed description of the cutter.

Below the outer shell 7, two valves 11 are arranged on both sides of the cutter 9. These valves 11 are connected to the two media tanks 3, 4 by means of lines 12. Thus by means of these valves 11, the media from both the media tanks 3, 4 are conveyed further to the media outlet openings 14. An arrangement of valves 11 on both sides of the cutter 111 enables the operation of the cutting- and transport roller in both directions of rotation. As mentioned already, the valves 11 convey the media to the media outlet openings 14 inserted as radial boreholes into the media strips 13, which can be designed as hollow elements.

List of Reference Symbols

| | |
|---|---|
| 1 | Cutting- and transport roller |
| 2 | Bearing pin |
| 3 | Media tank |
| 4 | Media tank |
| 5 | Pipe penetration |
| 6 | Web plate |
| 7 | Outer shell |
| 8 | Flat portion |
| 9 | Cutter |
| 10 | Cutting knives |
| 11 | Valve |
| 12 | Lines |
| 13 | Media strip |
| 14 | Media outlet openings |

1. Cutting and transport roller (1) for material webs,
that comprises of media outlet openings (14) in its peripheral surface (7) to which varying pressure can be applied to control the seating pattern of the material web on the peripheral surface (7) of the roller (1) and
that comprises of a system of pressure feed lines (3, 4, 5, 11, 12, 13) by means of which the media outlet openings (14) are connected to means for supplying the media.
characterized by
at least one pressure reservoir (3, 4)
that (3, 4) is a part of the pressure feed line system (3, 4, 5, 11, 12, 13) and
that can be connected by a valve to at least one part of the media outlet openings.

2. Cutting- and transport roller (1) pursuant to claim 1
characterized in that
at least one valve (11)
by which it is possible to interrupt the connection of the media outlet openings (14) and the pressure reservoir,
is arranged inside the roller (1).

3. Device pursuant to claim 1,
characterized by
at least one pressure reservoir (3, 4) that is arranged in the roller (1).

4. Device pursuant to claim 3
characterized in that
at least one pressure reservoir is designed as a compressed air tank (3, 4) that is inserted into the roller (1) as a separate component.

5. Device pursuant to claim 4
characterized in that
the walls if the roller (1) and the walls of the compressed air tank (3, 4) form a line of contact to the maximum extent possible.

6. Device pursuant to claim 4
characterized in that
the walls of the roller (1) and the pressure reservoir (3, 4) are independent of one another.

7. Process for controlling the seating pattern of a material web on the peripheral surface of a cutting and transport roller (1)
in which media of varying pressure are applied from time to time to the media outlet openings (14) in the peripheral surface (7) of the roller (1) and the material web is selectively lifted off or laid down on the peripheral surface (7) and
in which media of varying pressure are supplied using means provided for this purpose and
the media are supplied to the media outlet openings (14) by means of a pressure line system (3, 4, 5, 11, 12, 13),
characterized in that
a static pressure is built up in components of the pressure line system (3, 4, 5, 11, 12, 13) by the means for supplying the media of varying pressure,
and that this pressure is applied to the media outlet openings (14) by the opening of the valves (11).

8. Process pursuant to claim 7
characterized in that
the means for supplying the media of varying pressure continue to operate even when the valves (11) are opened.

9. Process pursuant to claim 8
characterized in that
when the valves (11) are closed, the means for supplying the media of varying pressure continue to operate till a predetermined amount of pressure is built up.

10. Device for winding up web-shaped material characterized by
a cutting and transport roller (1) in accordance with claim 1.

11. Device pursuant to claim 2,
characterized by
at least one pressure reservoir (3, 4) that is arranged in the roller (1).

12. Process pursuant to claim 7
characterized in that
when the valves (11) are closed, the means for supplying the media of varying pressure continue to operate till a predetermined amount of pressure is built up.
